(19) United States
(12) Patent Application Publication
(10) Pub. No.: US 2019/0140493 A1
(43) Pub. Date: May 9, 2019

(54) STATOR AND SINGLE-PHASE MOTOR

(71) Applicant: MABUCHI MOTOR CO., LTD., Chiba (JP)

(72) Inventor: Takuya TAKAHASHI, Chiba (JP)

(21) Appl. No.: 16/133,712

(22) Filed: Sep. 18, 2018

(30) Foreign Application Priority Data
Nov. 9, 2017 (JP) 2017-216510

(51) Int. Cl. H02K 1/14; H02K 1/27; H02K 3/18; H02K 3/32; A45D 20/12

(52) U.S. Cl. CPC H02K 1/141; H02K 1/2726; A45D 20/12; H02K 3/325; H02K 3/18

(57) ABSTRACT

Provided is a stator of a single-phase motor with which an efficient magnetic circuit can be formed and a large torque can be obtained. The stator includes a pair of stator cores each having C-shape in a plan view and including distal end portions E disposed proximate to an outer peripheral surface of an axial rotor having a rotating shaft. The stator cores are disposed to opposite to each other with the rotor disposed therebetween in a first radial direction X orthogonal to an axial direction along a central axis line O of the rotating shaft. The stator cores include a pair of arm portions each extending in a radial direction intersecting the first radial direction X, and a base portion. The base portion connects ends of the arm portions on the opposite side from the distal end portions E, and extends in a circumferential direction encircling the central axis line O.

### BACKGROUND

### 1. Technical Field

The present invention relates to a stator and a single-phase motor.

### 2. Description of the Related Art

A single-phase motor has been known which, as described in JP-A-2017-123772, is provided with an axial rotor having a rotating shaft and being rotatably disposed, and a pair of C-shaped stator cores having distal end portions disposed proximate to the outer peripheral surface of the rotor. The stator cores are disposed to opposite to each other with the rotor disposed therebetween in a first radial direction of the rotating shaft. Each of the stator cores is provided with a pair of arm portions extending in parallel with the first radial direction.

Generally, such single-phase motors are used in small-sized electric appliances, such as a hair dryer that a user holds by one hand during use. Accordingly, there is a need to reduce the size and weight of the single-phase motors for the sake of convenience of the appliance.

### SUMMARY

However, in the conventional single-phase motor, the pairs of arm portions of the stator cores extend in parallel with the first radial direction. Accordingly, it has been difficult to form an efficient magnetic circuit with respect to magnetic fluxes extending radially and in a radiating manner from the outer peripheral surface of the rotor, making it difficult for the single-phase motor to provide a large torque.

The present invention has been made in view of the above circumstance, and an object of the present invention is to provide a stator of a single-phase motor with which an efficient magnetic circuit can be formed and a large torque can be obtained.

In order to solve the problem, the present invention proposes the following means.

A single-phase motor according to an embodiment includes a pair of stator cores having C-shape in a plan view and including a distal end portion disposed proximate to an outer peripheral surface of an axial rotor having a rotating shaft. The pair of stator cores is disposed to opposite to each other with the rotor disposed therebetween in a first radial direction orthogonal to an axial direction along a central axis line of the rotating shaft. Each of the stator cores includes a pair of arm portions each extending in a radial direction intersecting the first radial direction in the plan view, and a base portion connecting ends of the pair of arm portions on the opposite side from the distal end portion, and extending in a circumferential direction encircling the central axis line.

According to the embodiment, each of the pair of stator cores disposed to opposite to each other with the rotor disposed therebetween in the first radial direction is provided with the pair of arm portions each extending in a radial direction intersecting the first radial direction. Accordingly, by aligning the direction of extension of the arm portions of the stator cores with the direction of a magnetic flux extending radially and in a radiating manner from the outer peripheral surface of the rotor, an efficient magnetic circuit can be formed. Thus, in the single-phase motor configured from the stator and the rotor, it becomes possible to effectively utilize the magnetic flux extending from the rotor, and to obtain a large torque.

In the stator according to an embodiment, in the plan view, the pair of arm portions of each of the stator cores may form an angle such that a central angle about the central axis line is 70° or more.

In this case, the pair of arm portions of each of the stator cores forms an angle of 70° or more in the plan view. Accordingly, it becomes possible to ensure an interval between arm portions adjacent to each other in the circumferential direction, and to ensure a space for winding coils around the arm portions of the stator cores.

In the stator according to an embodiment, in the plan view, the pair of arm portions of each of the stator cores may form an angle such that a central angle about the central axis line is 90°.

In this case, the pair of arm portions of each of the stator cores forms an angle of 90° in the plan view. Accordingly, a more efficient magnetic circuit can be formed.

The stator according to an embodiment may further include a coil that forms a magnetic circuit in the stator cores, and an insulator holding the stator cores.

In this case, it becomes possible to configure the stator cores as the stator.

A single-phase motor according to an embodiment includes an axial rotor having a rotating shaft and being rotatably disposed, and a stator covering the rotor from an outer side radially. The stator may be the stator described above.

In this case, it becomes possible to obtain the above-described operations and effects in a single-phase motor.

In the single-phase motor according to an embodiment, the rotating shaft of the rotor may be fitted with a bearing unit rotatably holding the rotating shaft. The bearing unit may have disposed thereon a plurality of supports extending in the axial direction and arranged at intervals in the circumferential direction, the plurality of supports surrounding the rotor from the outer side radially. The stator may be fitted between the supports that are disposed adjacent to each other in the circumferential direction.

In this case, the plurality of supports is arranged at intervals in the circumferential direction on the bearing unit holding the rotating shaft, and the stator is fitted between the supports. By fitting the stator between the supports, it becomes possible to achieve radial alignment easily for forming a predetermined gap between the rotor and the stator.

In the single-phase motor according to an embodiment, the insulator may include a plurality of inner-side holding portions disposed on an inner side radially thereof and arranged at intervals in the circumferential direction, the plurality of inner-side holding portions holding an inner side radially of the stator cores. Each of the inner-side holding portions may be formed with first mating groove portions in both side surfaces thereof facing outward in the circumferential direction, the first mating groove portions having a triangular shape in a top plan view. Each of the supports may be formed with second mating groove portions in both side surfaces thereof facing outward in the circumferential direction, the second mating groove portions having a triangular shape in the top plan view. The stator may fitted between the supports with the first mating groove portions and the second mating groove portions being engaged with each other without a gap in the circumferential direction.

In this case, the first mating groove portions of the inner-side holding portions of the insulator and the second mating groove portions of the supports of the bearing unit are engaged with each other without a gap in the circumferential direction, and the stator is fitted between the supports. Accordingly, development of a gap between the inner-side holding portions and the supports is prevented. Thus, when a fan for blowing air toward the stator is coupled with the single-phase motor during use, for example, it becomes possible to prevent turbulence in a gap between the inner-side holding portions and the supports. In this way, the fan can be driven by the single-phase motor efficiently.

Further, the first mating groove portions and the second mating groove portions have a triangular shape in the top plan view. Accordingly, it is possible for the first mating groove portions and the second mating groove portions to exert a radially engaging force. As a result, it is possible to effectively regulate relative radial movement of the rotor and the stator cores.

According to the present invention, an efficient magnetic circuit can be formed and a large torque can be obtained.

### BRIEF DESCRIPTION OF THE DRAWINGS

FIG. 1 is a schematic cross-sectional diagram of a single-phase motor according to a first embodiment of the present invention;

FIG. 2 is a perspective view illustrating the exterior of the single-phase motor illustrated in FIG. 1;

FIG. 3A is a perspective view illustrating the exterior of a coil unit of the single-phase motor illustrated in FIG. 1;

FIG. 3B is a perspective view illustrating the exterior of a rotor unit of the single-phase motor illustrated in FIG. 1;

FIG. 4 is a schematic cross-sectional diagram of a single-phase motor according to a second embodiment of the present invention; and

FIG. 5 is a schematic cross-sectional diagram of a single-phase motor according to a third embodiment of the present invention.

### DESCRIPTION OF THE EMBODIMENTS

### First Embodiment

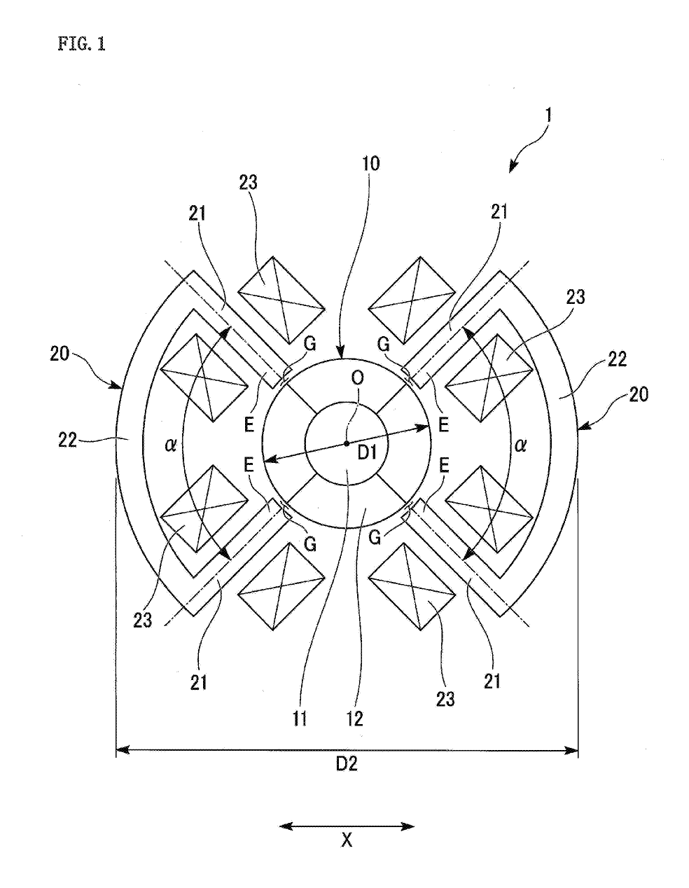

In the following, a single-phase motor 1 according to a first embodiment of the present invention will be described with reference to FIG. 1 to FIG. 3.

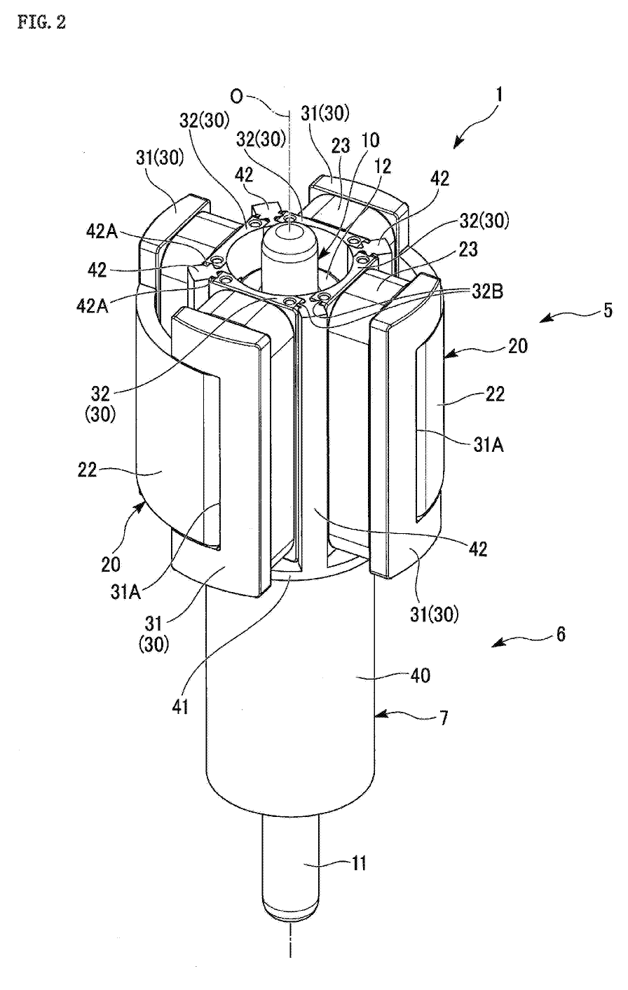

As illustrated in FIG. 1 and FIG. 2, the single-phase motor 1 is provided with a rotor unit 6 including an axial rotor 10 having a rotating shaft 11 and being rotatably disposed, and a stator 5 covering the rotor 10.

In the following description, the direction of a central axis line O of the rotating shaft 11 will be referred to as an axial direction. In a plan view from the axial direction, a direction orthogonal to the central axis line O will be referred to as a radial direction, and a direction encircling the central axis line O will be referred to as a circumferential direction. A radial direction will be referred to as a first radial direction X.

A radial direction toward the central axis line O corresponds to “inner side”. A radial direction away from the central axis line O corresponds to “outer side”.

As illustrated in FIG. 1 and FIG. 2, the rotor 10 extends in the axial direction. The rotor 10 is provided with the rotating shaft disposed at the center radially and a ring magnet 12 covering the rotating shaft 11 from the outer side radially. The ring magnet 12 is magnetized with an S-pole and an N-pole alternately in the circumferential direction. In the illustrated example, the ring magnet 12 is provided with four magnetic poles which are disposed at 90° intervals in the circumferential direction. Magnetic fluxes extend radially and in a radiating manner from the outer peripheral surface of the ring magnet 12.

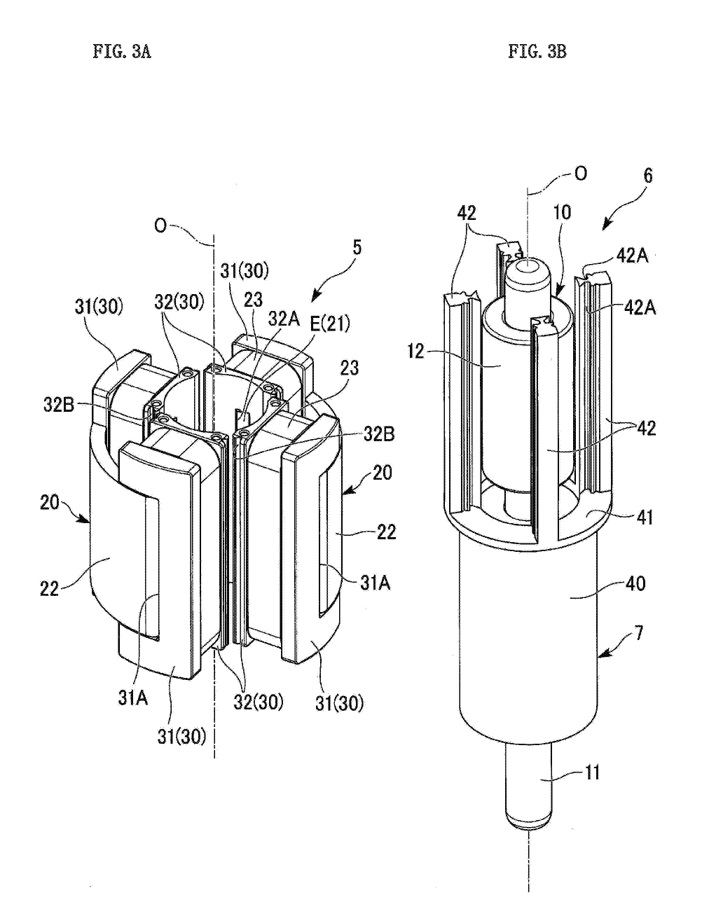

As illustrated in FIG. 3B, the rotor unit 6 has a columnar shape extending in the axial direction. The rotor unit 6 is provided with the rotor 10 and a bearing unit 7 rotatably holding the rotating shaft 11 of the rotor 10.

The ring magnet 12 of the rotor 10 is disposed on one side in the axial direction of the rotating shaft 11. The ring magnet 12 is fixed to the rotating shaft 11 by means of an adhesive agent, for example. The bearing unit 7 is attached to the other side in the axial direction of the rotating shaft 11.

The bearing unit 7 is provided with a bearing (not illustrated) fitted on the other side in the axial direction of the rotating shaft 11, and a cylindrical bearing holder 40 covering the bearing from the outer side radially. At the end of the bearing holder 40 on one side in the axial direction, a flange portion 41 protruding radially outward is formed. The bearing holder 40 may be inserted into a device into which the single-phase motor 1 is assembled.

On an outer end surface of the flange portion 41 facing one side in the axial direction, supports 42 are formed. The supports 42 extend toward one side in the axial direction from the outer end surface of the flange portion 41. The plurality of supports 42 is disposed at intervals in the circumferential direction on the outer end surface of the flange portion 41. In the illustrated example, four supports 42 are disposed.

As illustrated in FIG. 3A, the stator 5 has a cylindrical shape extending in the axial direction, and covers the rotor 10 from the outer side radially.

The stator 5 is provided with stator cores 20, insulators 30 holding the stator cores 20, and coils 23 which are wound around arm portions 21 of the stator cores 20 to form magnetic circuits through the stator cores 20.

The stator cores 20 have C-shape in a plan view from the axial direction. The pair of stator cores 20 is disposed to opposite to each other with the rotor 10 disposed therebetween in the first radial direction X. The pair of stator cores 20 has the same shape and size, and is disposed symmetrically with respect to the central axis line O.

The stator cores 20 have distal end portions E at the radially inner end portion. The distal end portions E are disposed proximate to the outer peripheral surface of the rotor 10.

Each of the stator cores 20 is provided with a pair of arm portions 21 each extending in a direction intersecting the first radial direction X in the plan view, and a base portion 22 extending in the circumferential direction. The arm portions 21 and the base portion 22 are integrally formed. The size of the arm portions 21 in the circumferential direction and the size of the base portion 22 radially are equal to each other. That is, the stator cores 20 have a uniform thickness both circumferentially and radially in the plan view throughout the stator cores 20.

The inner end portions radially of the pair of arm portions 21 are the distal end portions E, which are proximate to the outer peripheral surface of the rotor 10 radially. Between each of the distal end portions E of the stator cores 20 and the outer peripheral surface of the ring magnet 12 of the rotor 10, an air gap G is formed.

The air gap G is formed between each of the distal end portions E of the stator cores 20 and the ring magnet 12 of the rotor 10. The respective air gaps G have the same size radially.

The base portion 22 connects the outer end portions (the end portions on the opposite side from the distal end portions E) radially of each pair of arm portions 21. The base portion 22 of the stator cores 20 has an arc shape which is coaxial with the central axis line O.

In the present embodiment, in the plan view, each pair of arm portions 21 of the stator cores 20 forms an angle α such that a central angle about the central axis line O is 70° or more. In the illustrated example, the angle α is 90°.

In the illustrated example, as representative dimensions of various portions, an outer diameter D1 of the rotor 10 is 1.5 mm to 30 mm, and a distance D2 between the outer peripheral surfaces of the base portions 22 of the pair of stator cores 20 is 6 mm to 50 mm.

The plurality of insulators 30 is disposed at intervals in the circumferential direction. The insulators 30 are provided with outer-side holding portions 31 disposed at the outer end portion radially of the stator cores 20, and inner-side holding portions 32 disposed at the inner end portion radially of the stator cores 20. The plurality of inner-side holding portions 32 is disposed at intervals in the circumferential direction.

The outer-side holding portions 31 and the inner-side holding portions 32 extend in the circumferential direction in the plan view. The outer-side holding portions 31 and the inner-side holding portions 32 are formed from synthetic resin material and are insulating.

The outer-side holding portions 31 are disposed at connection portions between the arm portions 21 and the base portion 22 of the stator cores 20. The plurality of the outer-side holding portions 31 has an outer peripheral surface which has an arc shape extending in the circumferential direction in the plan view. The plurality of the outer-side holding portions 31 is disposed at intervals in the circumferential direction. The outer peripheral surface of each of the plurality of the outer-side holding portions 31 has the arc shape, which is coaxial with the central axis line O.

Each of the outer-side holding portions 31, in a plan view from the outer side radially, is formed with an accommodating recess portion 31A which penetrates through the outer-side holding portion 31 radially and which is open on one side in the circumferential direction. The accommodating recess portion 31A accommodates the base portion 22 of the stator cores 20. The outer peripheral surface of the outer-side holding portions 31 and the outer peripheral surface of the base portion 22 are flush radially.

The inner-side holding portions 32 are disposed at the distal end portions E of the arm portions 21 of the stator cores 20. The inner-side holding portions 32 have an inner peripheral surface which has an arc shape extending in the circumferential direction in the plan view. The plurality of the inner-side holding portions 32 is disposed at intervals in the circumferential direction. The inner peripheral surface of each of the plurality of inner-side holding portions 32 has the arc shape, which is coaxial with the central axis line O.

The inner peripheral surface of the inner-side holding portions 32 is opposed to the outer peripheral surface of the rotor 10 via a gap radially.

Each of the inner-side holding portions 32 is formed with a passing hole 32A penetrating radially through the inner-side holding portions 32, in a plan view from the outer side radially. Each of the distal end portions E of the arm portions 21 of the stator cores 20 is passed into the passing hole 32A.

First mating groove portions 32B are formed in both side surfaces, facing outward in the circumferential direction, of the outer surface of the inner-side holding portions 32. The first mating groove portions 32B are recessed inward in the circumferential direction. The first mating groove portions 32B extend throughout both side surfaces in the axial direction of the inner-side holding portions 32. The first mating groove portions 32B have a triangular shape in the plan view from the axial direction.

The mating state between the stator 5 and the rotor unit 6 will be described.

The supports 42 of the rotor unit 6 have a rectangular shape in the plan view from the axial direction. The supports 42 include, in the vicinity of the inner end portion radially thereof, second mating groove portions 42A recessed inward in the circumferential direction. The second mating groove portions 42A are formed in both side surfaces in the circumferential direction of each of the supports 42. The second mating groove portions 42A have a triangular shape in a top plan view, and extend throughout in the axial direction of the supports 42.

The stator 5 is fitted between the supports 42 that are adjacent to each other in the circumferential direction. The stator 5 is fitted between the supports 42 with the first mating groove portions 32B and the second mating groove portions 42A being engaged with each other without a gap in the circumferential direction.

When the stator 5 and the rotor unit 6 are mated, the end portion on one side in the axial direction of the rotor unit 6 is inserted from the end portion on the other side in the axial direction of the stator 5.

In this case, the ring magnet 12 of the rotor unit 6 is passed along the inner side radially of the inner-side holding portions 32 of the insulators 30 of the stator 5. Accordingly, the outer peripheral surface of the ring magnet 12 of the rotor unit 6 and the distal end portions E of the arm portions 21 of the stator cores 20 of the stator 5 are opposed to each other via the air gap G formed radially.

Also, the supports 42 on the bearing holder 40 of the rotor unit 6 are each inserted between the inner-side holding portions 32 that are adjacent to each other in the circumferential direction of the insulators 30 of the stator 5. In this way, the first mating grooves of the inner-side holding portions 32 and the second mating grooves of the supports 42 are engaged with each other without a gap in the circumferential direction.

In this state, relative rotation of the stator 5 and the rotor unit 6 in the circumferential direction is regulated. The rotor 10 is rotatably held with respect to the stator 5 and the bearing unit 7.

As described above, in the single-phase motor 1 according to the present embodiment, each of the pair of stator cores 20 disposed to opposite to each other in the first radial direction X with the rotor 10 disposed therebetween is provided with the pair of arm portions 21 each extending in a radial direction intersecting the first radial direction X.

Accordingly, by aligning the directions of extension of the arm portions 21 of the stator cores 20 with the directions of magnetic fluxes extending radially and in a radiating manner from the outer peripheral surface of the rotor 10, an efficient magnetic circuit can be formed. In this way, it becomes possible to effectively utilize the magnetic fluxes extending from the rotor 10 and to obtain a large torque.

The angle α formed by the pair of arm portions 21 of the stator cores 20 in the plan view is 70° or more. Accordingly, it is possible to ensure an interval between the arm portions 21 adjacent to each other in the circumferential direction, and to ensure a space for winding coils around the arm portions 21 of the stator cores 20.

The angle α formed by the pair of arm portions 21 of the stator cores 20 in the plan view may be 90°. In this way, a more efficient magnetic circuit can be formed.

The stator 5 is provided with the coils 23 for forming magnetic circuits through the stator cores 20, and the insulators 30 holding the stator cores 20. Accordingly, the stator cores 20 can be configured as the stator 5.

The plurality of supports 42 is disposed at intervals in the circumferential direction on the bearing unit 7 holding the rotating shaft 11. The stator 5 is fitted between the supports 42. By fitting the stator 5 between the supports 42, radial alignment for forming the predetermined gap G between the rotor 10 and the stator 5 can be easily achieved.

The stator 5 is fitted between the supports 42 with the first mating groove portions 32B of the inner-side holding portions 32 of the insulators 30 and the second mating groove portions 42A of the supports 42 of the bearing unit 7 being engaged with each other without a gap in the circumferential direction. By suppressing the gap between the inner-side holding portions 32 and the supports 42, it becomes possible, when a fan for blowing air toward the stator 5 is coupled with the single-phase motor 1 during use, for example, to suppress the occurrence of turbulence in the gap between the inner-side holding portions 32 and the supports 42. Thus, the fan can be efficiently driven by the single-phase motor 1.

The first mating groove portions 32B and the second mating groove portions 42A both have a triangular shape in a top plan view. Accordingly, the first mating groove portions 32B and the second mating groove portions 42A can exert an engaging force radially. Thus, relative radial movement of the rotor 10 and the stator cores 20 can be effectively regulated.

### Second Embodiment

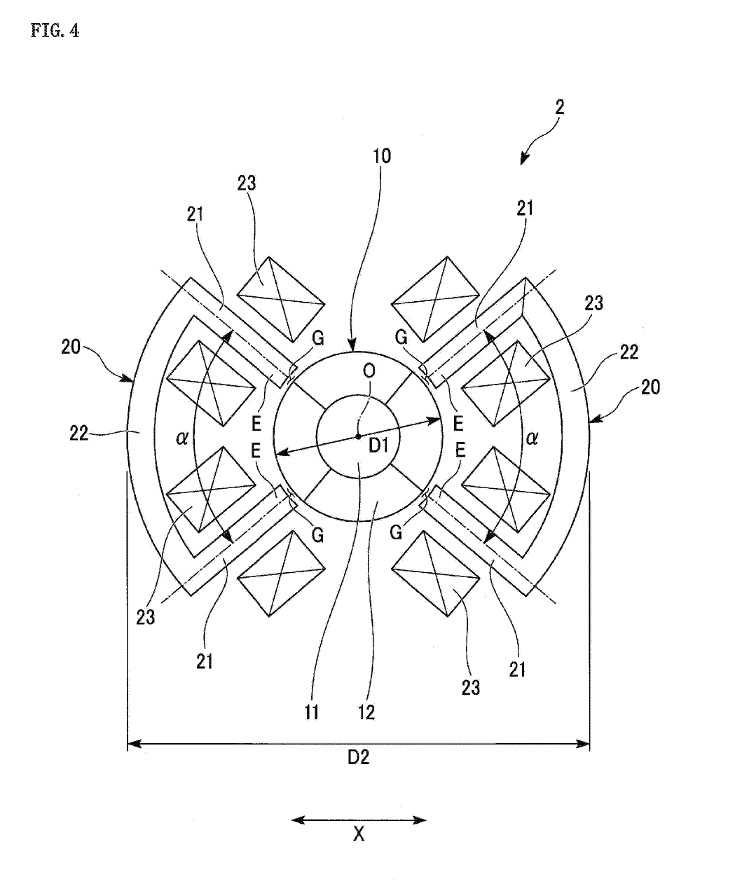

A second embodiment of the present invention will be described with reference to FIG. 4. In the embodiment described below, configurations same as those of the first embodiment are designated with the same signs and their description will be omitted, focusing instead on differences.

As illustrated in FIG. 4, in a single-phase motor 2 according to the present embodiment, the angle α formed by the pair of arm portions 21 of the stator cores 20 is 80° in the plan view.

### Third Embodiment

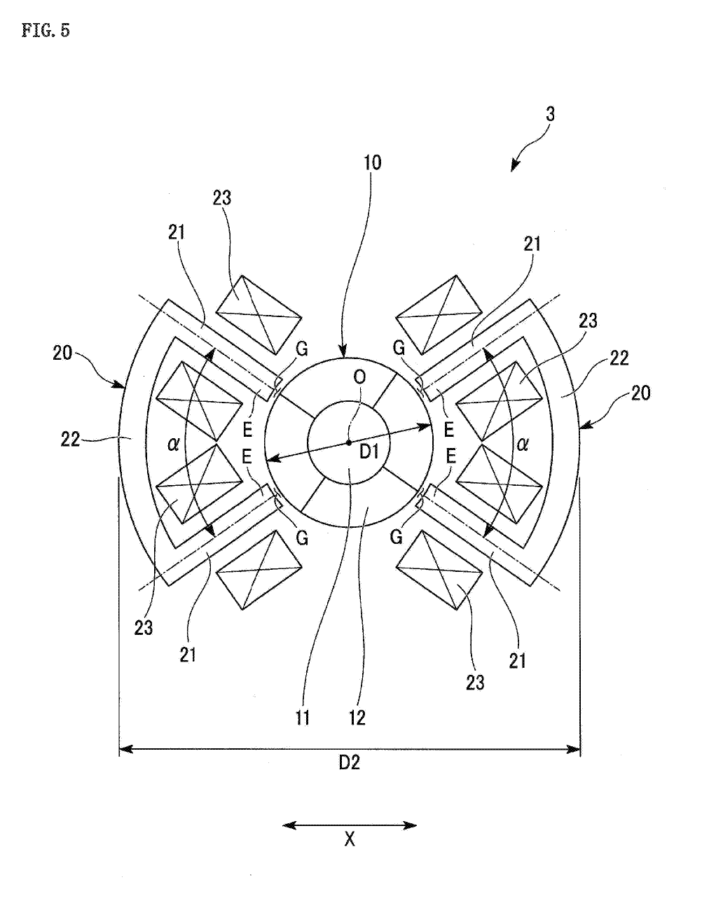

A third embodiment of the present invention will be described with reference to FIG. 5. In the embodiment described below, configurations same as those of the first embodiment are designated with the same signs and their description will be omitted, focusing instead on differences.

As illustrated in FIG. 5, in a single-phase motor 3 according to the present embodiment, the angle α formed by the pair of arm portions 21 of the stator cores 20 in the plan view is 70°.

### Verification Test

The results of verification of the operation and effects of the embodiments will be described.

In the verification test, the single-phase motor 1 of the first embodiment was adopted as Example 1; the single-phase motor 2 of the second embodiment was adopted as Example 2; and the single-phase motor 3 of the third embodiment was adopted as Example 3.

As Comparative Example 1, a single-phase motor having a configuration in which, as indicated in JP-A-2017-123772, a pairs of arm portions 21 of the stator cores 20 extend in parallel with the first radial direction X was adopted.

With respect to the single-phase motor of each configuration, the torque when the number of rotations per minute was 120,000 was measured. The torque measurement was performed 5 times with respect to each configuration, and an average value of the measurements was calculated.

As a result, the torque was 0.0115 (N·m) in Example 1; 0.0104 (N·m) in Example 2; and 0.0091 (N·m) in Example 3. In Comparative Example 1, the torque was 0.0071 (N·m).

That is, it was confirmed that, compared with the rotating torque of the single-phase motor of Comparative Example, Example 1 had an improvement of 61%, Example 2 had an improvement of 46%, and Example 3 had an improvement of 28%. Thus, it has been confirmed from the results that, compared with the single-phase motor of Comparative Example, the single-phase motors 1 to 3 of the present invention can suppress the occurrence of a magnetic short and provide a large torque.

It has also been confirmed that the torque is most significantly increased in Example 1, in which the angle α formed by the pair of arm portions 21 was 90°. This is because when the angle α formed by the pair of arm portions 21 is 90°, efficient magnetic circuits can be formed with respect to the magnetic fluxes extending radially and in a radiating manner from the four magnetic poles disposed at 90° intervals on the outer peripheral surface of the rotor 10.

The technical scope of the present invention is not limited to the embodiments, and various modifications may be made without departing from the spirit and scope of the present invention.

For example, while in the foregoing embodiments, the angle α formed by the pair of arm portions 21 is 90° or less, this is not a limitation. The angle α formed by the pair of arm portions 21 may be greater than 90°. Preferably, in this case, the angle α formed by the pair of arm portions 21 may be 110° or less. This is in order to avoid the problem of being unable to wind the coils around the arm portions 21 due to a decrease in the interval in the circumferential direction between the arm portions 21 on one side of each of the stator cores 20 adjacent to each other in the circumferential direction.

It is also possible to substitute, as appropriate, known constituent elements for the constituent elements in the embodiments without departing from the spirit and scope of the present invention. The modifications may be combined, as appropriate.

### REFERENCE SIGNS LIST

1, 2, 3 Single-phase motor
5 Stator
10 Rotor
11 Rotating shaft
20 Stator cores
21 Arm portion
22 Base portion
23 Coil
30 Insulator
E Distal end portion

1. A stator comprising a pair of stator cores having C-shape in a plan view and including a distal end portion disposed proximate to an outer peripheral surface of an axial rotor having a rotating shaft,
wherein:
the pair of stator cores is disposed to opposite to each other with the rotor disposed therebetween in a first radial direction orthogonal to an axial direction along a central axis line of the rotating shaft; and
each of the stator cores includes
a pair of arm portions each extending in a radial direction intersecting the first radial direction in the plan view, and
a base portion connecting end portions of the pair of arm portions on the opposite side from the distal end portion and extending in a circumferential direction encircling the central axis line.

2. The stator according to claim 1, wherein, in the plan view, the pair of arm portions of each of the stator cores forms an angle such that a central angle about the central axis line is 70° or more.

3. The stator according to claim 1, wherein, in the plan view, the pair of arm portions of each of the stator cores forms an angle such that a central angle about the central axis line is 90°.

4. The stator according to claim 1, further comprising:
a coil that forms a magnetic circuit in the stator cores; and
an insulator holding the stator cores.

5. A single-phase motor comprising:
an axial rotor having a rotating shaft and being rotatably disposed; and
a stator covering the rotor from an outer side radially,
wherein the stator is the stator according to claim 4.

6. The single-phase motor according to claim 5, wherein:
the rotating shaft of the rotor is fitted with a bearing unit rotatably holding the rotating shaft;
the bearing unit has disposed thereon a plurality of supports extending in the axial direction and arranged at intervals in the circumferential direction, the plurality of supports surrounding the rotor from the outer side radially; and
the stator is fitted between the supports that are disposed adjacent to each other in the circumferential direction.

7. The single-phase motor according to claim 6, wherein:
the insulator includes a plurality of inner-side holding portions disposed on an inner side radially thereof and arranged at intervals in the circumferential direction, the plurality of inner-side holding portions holding an inner side radially of the stator cores;
each of the inner-side holding portions is formed with first mating groove portions in both side surfaces thereof facing outward in the circumferential direction, the first mating groove portions having a triangular shape in a top plan view;
each of the supports is formed with second mating groove portions in both side surfaces thereof facing outward in the circumferential direction, the second mating groove portions having a triangular shape in the top plan view; and
the stator is fitted between the supports with the first mating groove portions and the second mating groove portions being engaged with each other without a gap in the circumferential direction.
